(19) United States
(12) Patent Application Publication
(10) Pub. No.: US 2023/0274689 A1
(43) Pub. Date: Aug. 31, 2023

(54) INTEGRATED DISPLAY AND SENSOR ARRAY

(71) Applicant: GM GLOBAL TECHNOLOGY OPERATIONS LLC, DETROIT, MI (US)

(72) Inventors: Jonglee Park, Troy, MI (US); Dorel M. Sala, Troy, MI (US)

(21) Appl. No.: 17/681,047

(22) Filed: Feb. 25, 2022

(51) Int. Cl. G09G 3/32; B60K 35/00

(52) U.S. Cl. CPC G09G 3/32; B60K 35/00; G09G 2360/144; G09G 2380/10; G09G 2354/00; B60K 2370/152; B60K 2370/171; B60K 2370/332; B60K 2370/48; B60K 2370/52; B60K 2370/62

(57) ABSTRACT

A display device includes a plurality of pixel elements, each pixel comprising a display portion and a sensor portion. The display portion includes a light source embedded in a backplane layer; the light source causes an image to be rendered by the display device. The sensor portion includes a sensor embedded in the same backplane layer, the sensor detects movement within a predetermined vicinity of the display device.

### INTRODUCTION

The subject disclosure relates to transparent display and sensing systems, particularly a display and sensing system integrated into surfaces of a vehicle.

New and innovative looks are desirable for vehicle information displays as vehicle manufacturers progress in vehicle designs. In the area of information displays, design goals include providing information displays that are easier to read, less costly, less bulky, less heavy, consume less energy, and are more flexible for various applications and ambient lighting conditions. Further, providing specific information on such displays, responsive to particular actions by a user, is desirable for improved customer experience. To this end, monitoring user movement in an efficient manner is desirable. Obtaining some or all of these goals opens the door for possible innovative design of improved display panels.

### SUMMARY

According to one or more aspects, a display device includes a plurality of pixel elements, each pixel comprising a display portion and a sensor portion. The display portion comprises a light source embedded in a backplane layer; the light source causes an image to be rendered by the display device. The sensor portion comprises a sensor embedded in the same backplane layer. The sensor detects movement within a predetermined vicinity of the display device.

In some examples, the sensor is a plurality of sensors.

In some examples, the light source is a plurality of light sources.

In some examples, the light source is a microLED.

In some examples, the sensor is a time-of-flight laser sensor.

In some examples, the display device includes a controller that receives a movement detection signal from the sensor, and in response, based on the movement detection signal, causes the light source to change the image being rendered.

In some examples, the display device includes a controller, and a light sensor that detects an amount of ambient light, wherein, in response to the amount of ambient light being below a predetermined threshold, the controller causes the light source to emit additional light to facilitate the sensor to detect movement in the vicinity.

In some examples, the display device includes a controller that causes the pixel elements to display a lock screen using the display portion of each of the pixel elements. The controller receives, from the sensor portion of one or more pixel elements from the plurality of pixels, a movement detection, and in response to the movement detection, causes the pixel elements to display a keypad to lock or unlock a vehicle.

In some examples, the plurality of pixel elements is a first plurality, and the display device further comprises a second plurality of pixel elements, wherein each of the second plurality of pixel elements comprises only the display portion.

According to some aspects, a method includes detecting, using a sensor portion of a pixel element of a display panel, a movement within a predetermined vicinity of the display panel, the display panel embedded on an exterior of a vehicle, the display panel is transparent. Further, the method includes, based on detecting the movement, displaying, by a display portion of the pixel element a keypad. Further, the method includes, in response to an input provided via the keypad displayed by the display portion, locking or unlocking the vehicle.

In some examples, the pixel element is a plurality of pixel elements of the display panel.

In some examples, the sensor portion and the display portion are commonly located on the same backplane layer of the pixel element.

In some examples, the pixel element is a first pixel element that comprises the display portion and the sensor portion, and wherein the display panel further comprises a second pixel element that comprises only the display portion.

In some examples, the display portion comprises one or more light sources, and the sensor portion comprises one or more sensors.

In some examples, the one or more light sources comprise a microLED.

In some examples, wherein the one or more sensors comprise a microsensor.

According to some aspects, a vehicle includes a transparent display panel embedded within glass layers of a glass panel. The display panel includes a plurality of pixel elements, each pixel comprising a display portion and a sensor portion. The display portion includes a light source. The light source causes an image to be rendered by the display device. The sensor portion includes a sensor. The sensor detects movement within a predetermined vicinity of the vehicle.

In some examples, the display panel is coupled with a vehicle security system of the vehicle, and the display portion renders a status of the vehicle being locked or unlocked.

In some examples, in response to detecting, by the sensor portion of the pixel element, the movement within the predetermined vicinity, the display portion renders a keypad to lock or unlock the vehicle.

In some examples, the vehicle is locked or unlocked based on an input via the keypad.

The above features and advantages and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 shows a top view of a display panel integrated with sensors according to one or more aspects;

FIG. 2A shows section view of an integrated panel according to one or more aspects;

FIGS. 2B and 2C show additional views of an integrated panel according to one or more aspects;

FIG. 3 depicts an example pixel in a pixel element according to one or more aspects;

FIGS. 4A and 4B depict example sensor and display portions in a pixel element according to one or more aspects;

FIG. 5 depicts a flowchart of a method to display content based on sensor measurements on the integrated panel according to one or more aspects;

FIG. 6 depicts a scenario where the integrated panel is used to facilitate locking/unlocking a vehicle according to one or more examples;

FIG. 7 shows an example view where the display panel is used as an exterior facing display in a vehicle;

panel;

FIG. 8 depicts an example interior infotainment system with a display panel;

FIG. 9 depicts an example structure of using the integrated panel as part of a transparent display in a vehicle according to one or more examples;

FIG. 10 shows another block diagram of a pixel element according to one or more examples; and

FIG. 11 shows a block diagram of a pixel element according to one or more examples.

### DETAILED DESCRIPTION

The following description is merely exemplary in nature and is not intended to limit the present disclosure, its application, or uses. It should be understood that throughout the drawings, corresponding reference numerals indicate like or corresponding parts and features. As used herein, the term module refers to processing circuitry that may include an application-specific integrated circuit (ASIC), an electronic circuit, a processor (shared, dedicated, or group) and memory that executes one or more software or firmware programs, a combinational logic circuit, and/or other suitable components that provide the described functionality.

It should be noted that although one or more aspects of display panels, particularly display panels integrated with sensors (“integrated panel”), are discussed in the context of an automotive vehicle, such as a car, a truck, a bus, a boat, a motor-bike, etc. the technical solutions described herein are applicable in other fields of application where such integrated panels are used. Accordingly, technical solutions described herein are not to be limited to any particular field of application, and they provide practical application to a technical challenge in several fields of application.

The technical solutions described herein address technical challenges with integrated display and sensor panels (“integrated panels”) and particularly transparent integrated panels, such as those using material like glass, plastic, or other such transparent material. Such integrated panels facilitate displaying information on top of the transparent material, such as on a surface of a window (interior surface and/or exterior surface), a back panel of a vehicle, a windshield of a vehicle, a glass door, etc. Although examples herein are described in the context of an automotive vehicle, the technical solutions described herein are applicable in other fields of application where such integrated panels are used.

Today, an automotive vehicle (“vehicle”), and particularly a component of the vehicle, performs an action in response to a user interacting with the vehicle (or the component) via an accessory device. For example, to lock and/or unlock the vehicle, the user may use a “keyfob.” The keyfob has a panel, such as with buttons. If the keyfob is lost and/or non-operative (e.g., loss of battery, malfunction, breakage, etc.), the user may not be able to access the vehicle. An existing solution to such a problem is adding a “keypad” to the vehicle's door (or some panel). The user can lock/unlock the vehicle by using a specific key combination via the keypad. However, the keypad is always present and visible on the vehicle, for example, at an edge of a door, near a door handle, etc. Such a keypad may make the vehicle aesthetically unattractive to some users.

The technical solutions described herein address such challenges. The technical solutions described herein facilitate an integrated panel that includes display elements and sensors. Further, the technical solutions described herein facilitate the panel to be integrated on a transparent material, which can be used as a windowpane, for example. The integrated transparent panel can sense user movement and responsively display information in one or more aspects. For example, predetermined movements detected by the integrated panel can be associated with specific information being displayed. In addition, specific user movements detected by the integrated panel can be associated with predetermined actions/instructions to be taken by a controller in the vehicle. For example, a controller that handles locking/unlocking the vehicle may be instructed to lock/unlock the vehicle in response to a particular user movement sensed by the integrated panel. In this particular example, because the integrated panel is transparent, the aesthetics of the vehicle are not affected by the integrated panel being added to a window, door, or any other portion of the vehicle, and also alleviates the need for an accessory device (e.g., keyfob).

In some aspects, the technical solutions described herein facilitate embedding a transparent, integrated display and sensor panel in a surface of the vehicle, such as window, windshield, door, back panel, trim, or any other panel. The integrated panel may be laminated onto the surface. The integrated panel detects movement/motion within a predetermined vicinity, such as 6 inches, 10 inches, 2 feet, 4 feet, or any other such predetermined distance from the integrated panel. The integrated panel may switch the display ON in response to detecting motion. In some examples, when the display is ON, upon detecting a predetermined movement (“gesture”) by a user, the integrated panel may facilitate locking/unlocking the vehicle. The integrated panel displays the vehicle's lock/unlock status

In other examples, in response to detecting predetermined gestures, the integrated panel displays specific information about the vehicle's status, such as sensor measurements like fuel, tire pressure, oil life, battery charge, driving range, or any other such measurement or a combination thereof. The integrated panel can also display other types of information accessible from a local storage drive or a remote computer (e.g., via the Internet), such as news, stock prices, photographs, games, media, or other information. The integrated panel can display one or more specific types of information in response to particular movement/gestures, such as motion detection within a predetermined vicinity, a specific predetermined hand-movement, opening/closing of fueling panel, or any other such movement or a combination thereof. It is understood that the type of information displayed by the integrated panel is not limited by the examples described herein and that in other aspects, any other kind of information can be displayed by the integrated panel. The types of movements/motions/gestures detected by the integrated panel are not limited to the examples described herein. In other aspects, several other movements/motions/gestures can be detected and responded to by the integrated panel.

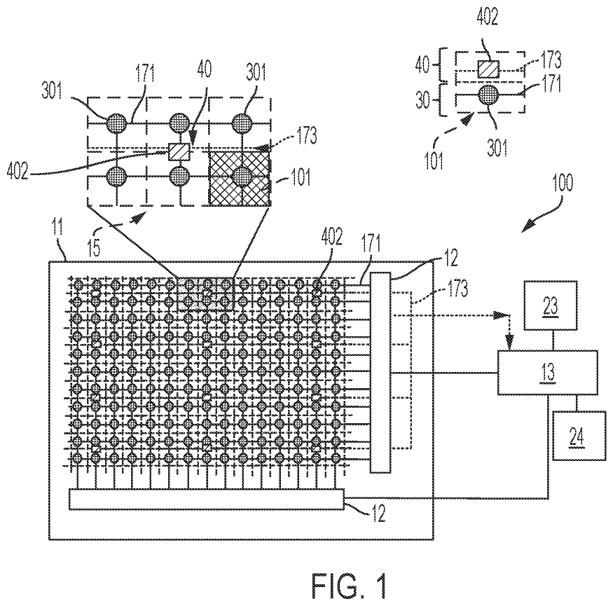

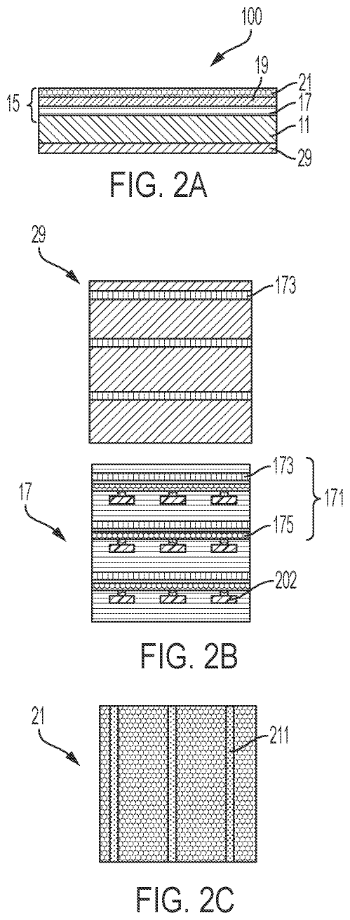

In accordance with an exemplary embodiment, FIG. 1 illustrates a top or plan view of an integrated panel 100 according to one or more aspects of the technical solutions described herein. FIG. 2A illustrates a side or sectional view of the integrated panel 100 of FIG. 1. It should be noted that FIG. 2A shows a sectional view of only a backplane portion to electrically control display or sensor elements on the integrated panel 100. Additional layers can be used in other examples. The layers that can include the display and/or sensor elements are not shown in the sectional view. Further, a protective layer (not shown), such as a substrate, can be on top of the layer that includes the display and sensor elements. It is understood that the number of components and dimensions shown in the figures herein are illustrative and that in one or more aspects of the present technical solutions, the number of components and dimensions can vary.

The integrated panel 100 may include a substrate 11 for supporting a pixel frame 15 that includes a plurality of pixel elements 101. Each pixel element 101 includes a display portion 30 (i.e., display components that can facilitate rendering/displaying information) and a sensor portion 40. The substrate 11 may be preferably made of an insulating material (e.g., glass or Acrylic) or other materials suitable for supporting the pixel frame 15. The pixel frame 15 encompasses a display area of the display panel (i.e., where an image is rendered by the integrated panel 100). In some examples (depicted in FIG. 1), several pixel elements 101 share a sensor 402, whereas each pixel element 101 includes a light source 301. Accordingly, the number of light sources 301 may exceed the number of sensors 402 in the integrated panel 100, in some examples.

The surface of substrate 11 is divided into multiple sub-regions, which are referred to as the pixel elements 101. It is noted that the divided pixel elements are not physically cut through, and the substrate 11 is not made by integrating the pixel elements 101. In other words, substrate 11 is a single or whole entity or an uncut entity. Further, it should be noted that the division of substrate 11 in FIG. 1 is illustrative and that in one or more examples, the integrated panel 100 is divided in a different manner (number of sub-regions, dimensions, etc.) depending on the resolution of the sub-regions and the integrated panel 100.

The integrated panel 100 may include several drivers 12, which are correspondingly disposed relative to (e.g., top, left, right, etc.) the pixel elements 101, respectively. In some examples, drivers 12 can include a gate driver and a source driver. It should be noted that the positions of drivers 12 are exemplified in FIG. 1; however, drivers 12 may be disposed in any other positions in other examples. A driver 12 is placed outside of the display area, which is encompassed by the pixel elements 101 that include the pixels that provide the display of the panel 100. A driver 12 may be an integrated circuit or chip, which is then bonded on the surface of the substrate 11. In some examples, driver 12 is mounted using surface-mount technology (SMT) such as chip-on-glass (COG) or flip-chip. Drivers 12 can include a scan line driver and a data line driver for the rows and columns, respectively.

Drivers 12 can drive the components of the pixel elements 101 of the integrated panel 100 using either passive or active matrix. In some examples, the integrated panel 100 includes a thin film transistor (TFT) to control the display image (i.e., content) shown by the pixel elements 101.

The integrated panel 100 further includes one or more controllers 13. The controllers 13 can include timing controllers (TCON), processing units, electronic control units (ECU), or other types of controllers. The controllers 13 can provide electrical signals to the components of the integrated panel 100 (for example, to operate the display). Controllers 13 can also receive electric signals from the components of the integrated panel 100 (for example, measurements from sensors). The controllers 13 are electrically connected with the substrate 11 for such transfer of electric signals, which may also be referred to as electronic data (“data”). In some examples, the controllers 13 may be connected to substrate 11 via a flexible printed circuit board (FPCB) (not shown). The controllers 13 can further be electrically connected with corresponding drivers 12, for example, via signal traces (not shown) disposed on the substrate 11. In some examples, one controller 13 may be electrically connected with at least two drivers 12. Accordingly, the number of the controllers 13 may be less than the number of the drivers 12. The controllers 13 may be electrically connected directly with corresponding drivers 12 via signal traces. Alternatively, the controllers 13 may be electrically connected to one driver 12 via signal traces and, after signal buffering, be electrically connected to another driver 12 via signal traces. The controllers 13 may be electrically connected to the sensors 402 to receive signals from the sensors 402.

The controllers 13 are coupled with other components. For example, the controllers 13 are coupled with a vehicle security system 23, which is responsible for controlling the locking/unlocking of a vehicle. The controllers 13 can be coupled with another display unit 24, for example, an infotainment system of the vehicle. The controllers 13 can be coupled with any other component in other examples and not limited to the examples described herein. In some examples, the vehicle security system 23 and the display unit 24 may be connected directly with the integrated panel 100 components (bypassing the controllers 13).

The pixel frame 15 can include several layers: a first bus lines layer 17, an insulator layer 19, and a second bus lines layer 21. The layers 17, 19, 21 in the pixel frame 15 facilitate integrating the display and sensor functionality within each pixel element 101. In some examples, the pixel frame can include additional layers, for example, a protective layer (not shown).

The insulator layer 19 separates the first bus lines layer 17 from the second bus lines layer 21. The insulator layer 19 may include one or more of the following non-limiting inorganic insulating materials exemplified as metal oxide high dielectric insulating materials such as a silicon oxide-based material; a silicon nitride (SiNy); and an aluminum oxide (Al2O3), such as polymethyl methacrylate (PMMA); polyvinyl phenol (PVP); and polyvinyl alcohol (PVA). In some aspects, organic insulating materials (organic polymers) such as octadecanethiol or dodecyl isocyanate, and a combination thereof may be used. In some aspects, the insulator layer 19 is made of transparent insulating material such as silicon, acrtlite, and epoxy. The examples above are non-limiting.

FIG. 2B depicts the first bus lines layer 17 according to one or more aspects. The first bus lines layer 17 includes multiple connectors 171, which are parallel to each other. The connectors 171 in the first bus lines layer 17 may be referred to as “horizontal bus lines” 171. As described further, the horizontal bus lines 171 can be categorized based on their connections in the pixel element 101. The horizontal bus lines 171 include sensor bus lines 173 that connect with one or more sensors 402 in the sensor portion 40 of the pixel element 101. The horizontal bus lines 171 can further include gate bus lines 175 that connect the light sources 301 in the display portion 30 of the pixel element 101. Further yet, the first bus lines layer 17 can also include one or more transistors 202 that respectively control the light sources 301. In some aspects, the sensor bus lines 173 are in a separate layer 29. The position of the layer 29, relative to the substrate 11, can be different from what is depicted in FIG. 2A. For example, in the depiction, the layer 29 is directly below the substrate 11. In other aspects, the substrate 11 may be directly below the layer 29.

FIG. 2C depicts the second bus lines layer 21 according to one or more aspects. The second bus lines layer 21 includes multiple connectors, 211, which are parallel to each other. The connectors 171 in the first bus lines layer 17 are perpendicular to the connectors 211 in the second bus lines layer 21. The connectors 211 in the second bus lines layer 21 may be referred to as “vertical bus lines” 211.

The horizontal bus lines 171 and the vertical bus lines 211 can be formed using suitable material that can conduct electrical signals. In some examples, a transparent conductive material is used, such as Al—Nd (alloy of aluminum and neodymium) or ASC (alloy of aluminum, samarium, and copper). Alternatively, or in addition, the horizontal bus lines 171 and the vertical bus lines 211 are formed using a conductive metal oxide, such as but not limited to, one or more of an indium oxide, an indium tin oxide (ITO, Sn-doped In2O3), an indium zinc oxide (IZO), and Indium gallium oxide (IGO), an indium gallium zinc oxide (IGZO), an indium tin zinc oxide (ITZO), an IFO (F-doped In2O3), a tin oxide (SnO2), an ATO (Sb-doped SnO2), an FTO (F-doped SnO2), a zinc oxide (including ZnO doped with other elements), and aluminum-zinc oxide (AZO), a gallium zinc oxide (GZO), a titanium oxide (TiO2), a niobium-titanium oxide (TNO), or any other such material or a combination thereof.

In some aspects, each pixel element 101 is located at a position on the substrate 11 where the horizontal bus lines 171 cross over the vertical bus lines 211. In some aspects, each sub-region that includes a pixel element 101 includes at least one cross over of the vertical bus lines 211 with the horizontal bus lines 171. Each pixel element 101 includes a display portion 30 and a sensor portion 40.

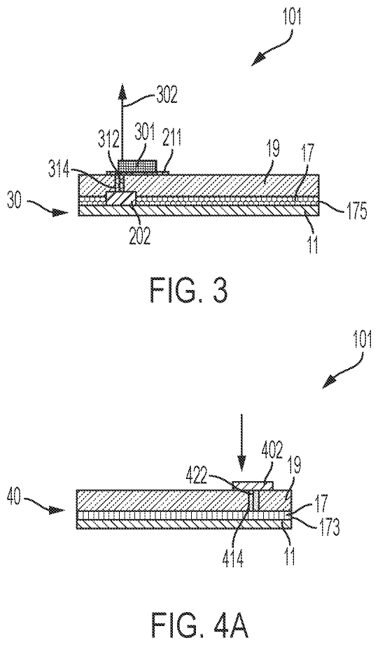

FIG. 3 depicts an example display portion 30 in a pixel element 101 according to one or more aspects. The pixel 30 that is shown includes a light source 301 that outputs light 302 to render/display the desired information. In some aspects, the rendering/displaying is provided by generating the output light 302 by the light source 301. The light source 301 can be a microLED in some aspects; however, other types of light sources can also be used.

In other aspects, the displaying/rendering may be provided using a reflective pixel pigment as the light source 301 to display the information using principles of light reflection. In yet other aspects, the displaying/rendering may be provided using a combination of a generative light source and reflective pixel pigment. The type of reflective material can vary from one aspect to another without affecting the technical solutions provided herein. For example, the reflective material can be electrophoretic material, such as Titanium dioxide (TiO2), in which the color and brightness of each pixel 30 are controlled by moving charged pigment particles of the display portion 30. Alternatively, the reflective material can include water, colored oil, and an electrode coated with a hydrophobic insulator to provide an electrowetting display. In electrowetting, with no voltage, the dyed oil in display portion 30 covers the entire pixel area and shows its color, and when the voltage is turned on, the colored area decreases to expose the background because the oil forms a drop. In yet other aspects, the reflective material includes electrochromic materials with electrolyte layers and electrodes for redox reactions. In this case, display portion 30 operates using electrochromic properties of the reflective material, where the visible color changes due to electrochemical reactions. It is understood that the above are just some examples of the reflective material that can be used for display portion 30 to display content and that in other examples, different types of reflective material or combinations thereof can be used without limiting the technical solutions provided herein.

The source bus lines 211 are connected to the light source 301. In some aspects, the light output 302 depends on the power provided to the light source 301. For example, color, brightness, and other such aspects or a combination thereof of the light output 302 can be adjusted by configuring the power supplied to the light source 301. The power to the light source 301 can be controlled using the transistor 202 in some aspects. The transistor 202 is connected to the source bus lines 211 and the gate bus lines 175. The source bus lines 211 are connected to the transistor 202 using a via 312, which is passed through a hole 314 in the insulator layer 19. The via 312 connects the source bus lines 211 with the gate bus lines 175. The transistor 202 is included in the pixel element 101. Drivers 12 can control the electrical signal to each display portion 30 based on signals from controllers 13.

In one or more aspects, display portion 30 can include additional components that are not shown.

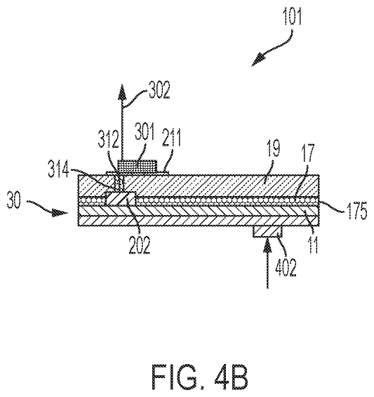

FIG. 4A depicts an example sensor portion 40 in a pixel element 101 according to one or more aspects. The sensor portion 40 includes a sensor 402. The sensor can be a camera, a depth sensor, radar, lidar, ambient light sensor, vertical-cavity surface-emitting laser (VCSEL) diode, single-photon avalanche diode (SPAD), or other such sensor and/or a combination thereof. The sensor 402 is connected to the sensor bus lines 173 using a via 422. The via 422 connects the sensor bus lines 173 and the sensor 402 through a hole 414 in the insulator layer 19.

The sensor 402 provides measurement signals in the form of electronic data (e.g., pulses, digital data, etc.) to the controllers 13. The controllers 13, based on the measurement signals from the sensors 402 determine what information is to be displayed by the display portion 30. Accordingly, in response to the measurement signals from the sensor portions 402 from one or more of the pixel elements 101, the controllers 13 can change/update the image rendered by the display portions 30.

In one or more aspects, sensor portion 40 can include additional components that are not shown.

Referring to FIG. 1, it should be noted that for some examples, all of the pixel elements 101 have both the display portion 30 and the sensor portion 40. In some examples, only a subset of the pixel elements 101 has both, the display portion 30 and the sensor portion 40, with the rest (or remainder) of the pixel elements 101 only having the display portion 30 (for display purposes). The pixel elements 101 that have both portions 30, 40 can be determined stochastically or according to a particular predetermined pattern. For example, every alternate pixel element 101 in a row and/or a column includes both portions 30, 40; every fifth pixel element 101 in each row and/or column includes both portions 30, 40, or any other such pattern can be selected at the time of manufacture. The number of pixel elements 101 in the pixel frame 15 of the integrated panel 100 depends on the resolution of the integrated panel 100.

In some aspects, drivers 12, the pixel frame 15, and other components are embedded between two layers of the substrate 11 (FIG. 2A). In some examples, a first substrate layer and a second substrate layer can use different substrate materials. For example, a layer may be a non-transparent material that supports the components (e.g., drivers, the pixel frame, etc.), and a layer may be made of a transparent material that facilitates a user to see the pixels (and hence content displayed). It should be noted that the integrated panel 100 can include additional components, such as facilitating a touchscreen capability using known techniques or techniques that will be developed in the future. The presence/absence of such components does not affect aspects of the technical solutions that are described herein.

FIG. 4B depicts an example view of the pixel element 101 according to one or more examples. Based on a movement detected by the sensor 402, the light source 301 emits light 302 to render information.

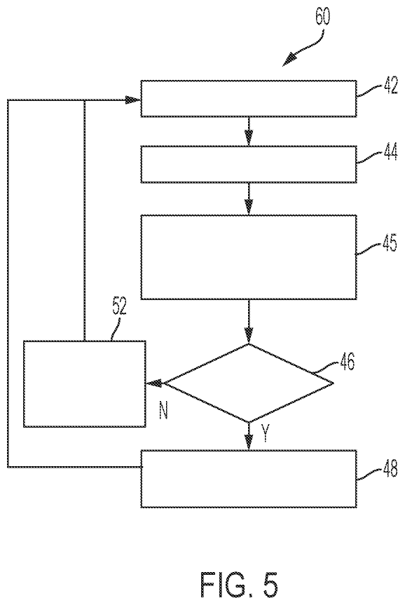

FIG. 5 depicts a flowchart of a method 60 to display content based on sensor measurements on the integrated panel 100 according to one or more aspects. Method 60 includes displaying the desired content via the integrated panel 100, at block 42. The content is displayed using the display portions 30 in pixel frame 15.

The method 60 further includes detecting movement using the sensor 402, at block 44. The movement is detected within a predetermined vicinity of the sensor 402. The movement detection can be performed by comparing sensor measurements from one or more sensors 402 at time t with sensor measurements the one or more sensors 402 at time t-n, n being a positive integer. In some cases, an aggregated measurement from a predetermined duration is compared with the measurement at time t to detect and/or determine the movement.

In some examples, the movement is captured/recorded. The captured movement can include a sequence of images, for example, grayscale images, intensity images, color images, or a combination thereof. Each sensor 402 can record a sequence of such images in some cases. An image can include color measurements, for example, red, green, blue (RGB) values at each pixel element 101. The image can alternatively, or in addition, include depth values (i.e., distance from the integrated panel 100 at which the movement occurred). Other sensor measurements can also be captured, such as ambient light.

In some examples, at block 45, based on the ambient light measurement from an ambient light sensor the controllers 13 cause the light sources 301 to brighten the area in the vicinity being monitored by the sensors 402. In some cases, the controllers 13 can further include other light sources (not shown) to brighten the area. The ambient light sensor (not shown) can be included in the sensor portion 40 in some examples. Alternatively, the ambient light sensor can be separate from the pixel frame 15. In yet other examples, the ambient light sensor (not shown) can be separate from the integrated panel 100.

For example, the integrated panel can be used as a security camera system installed on vehicle windows. The light sources that brighten the specific vicinity facilitate the security system to operate accurately even in the cases with low ambient light, such as at night time, in enclosed spaces, etc.

Further, at block 46, it is determined if the captured movement is actionable. The captured movement is compared with a predetermined pattern. For example, the controllers 13 can determine if the movement occurs for a predetermined duration (e.g., 2 seconds, 4 seconds, etc.). The controllers can determine if the movement is detected by at least a predetermined number of or proportion of sensors 402 in the integrated panel 100 (e.g., 5 sensors, 10 sensors, half of the total sensors, 30% of the total sensors, etc.). In yet other examples, the controllers 13 can determine if the movement is a specific gesture, such as predetermined movement of a hand, for example, waving a hand side-ways, specific pattern using one or more fingers (e.g., circle, zig-zag line, ‘N,’ ‘Z,’ sequence of digits, etc.). In yet other examples, the specific pattern can include a particular action performed by the user with respect to the vehicle, such as inserting a fuel-recharger (e.g., gasoline/diesel nozzle, electric charger, etc.) in the vehicle, inserting a tire inflator, and other such actions or a combination thereof. The movement is deemed to be actionable if the captured sensor measurements, such as intensity and/or color, meet a predetermined pattern at least within a predetermined threshold.

In some cases, the movement is deemed to be actionable only if the movement is performed within a predetermined vicinity of the integrated panel 100. The movement can be performed by the user within the vicinity of the integrated panel 100, and in some examples, without touching the integrated panel 100. The depth information from the sensors 402 are checked to determine if the movement was performed within a predetermined vicinity (e.g., one meter, two meters, etc.) of the integrated panel 100.

If it is deemed that the movement is actionable, the display of the integrated panel 100 is updated by sending appropriate display signals to the display portions 30, at block 48. If the movement is not deemed to be actionable (46), the display of the integrated panel 100 may be updated per a non-actionable movement being detected, at block 52. For example, the display portions 30 may be changed to a sleep mode. For example, the sleep mode may cause the display portions 30 to be switched off to conserve resources (e.g., power). Alternatively, in case of the non-actionable movement being detected, the display portions 30 are provided signals to display a predetermined content, such as a lock screen content. The lock screen content may be predetermined and user-configurable.

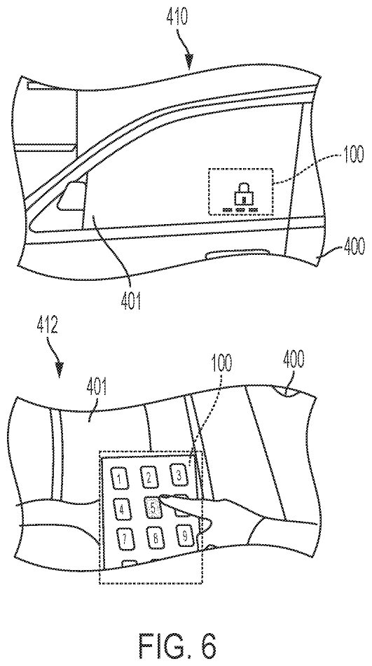

FIG. 6 depicts a scenario where the integrated panel 100 is used to facilitate locking/unlocking a vehicle according to one or more examples. The integrated panel 100 is embedded in a glass pane 401 of a vehicle 400. It is understood that the location of the integrated panel 100 with respect to the glass pane 401 and that of the vehicle 400 is relative and that in other examples, the integrated panel 100 may be located elsewhere on the vehicle 400.

The display portions 30 of the integrated panel 100 may be switched off, in sleep mode, or may display a lock screen (block 42) as shown in view 410 in FIG. 6. Upon detecting and capturing movement (block 44) that is deemed to be actionable (detecting user within the vicinity at block 46), the integrated panel 100 is updated (block 48), for example, to display a keypad, as shown in view 412 in FIG. 6. The movement may include a user entering within the predetermined vicinity of the integrated panel 100. Alternatively, or in addition, the user may perform a gesture, such as a swiping motion, a waving motion, or such other gesture or a combination thereof.

The user can interact with the keypad that is now displayed to lock/unlock the vehicle. For example, the user can enter a particular key combination to lock/unlock the vehicle. It is understood that in other examples, the integrated panel 100 can show different types of content (e.g., keypad, lock screen) than what is shown in FIG. 6. Further, while the illustration in FIG. 6 shows a numeric keypad, in other examples, the keypad may have additional or other types of characters. In yet other examples, the keypad may facilitate the user to lock/unlock the vehicle by drawing specific patterns rather than providing a combination of characters. Upon receiving user input via the integrated panel 100 when the keypad is visible, the controllers 13 compare the user-input with a vehicle key to determine if the vehicle 400 is to be locked/unlocked (i.e., change in status).

In other aspects, instead of displaying the keypad (at block 42), based on the detected movement being some other movement, the integrated panel 100 may display some other content (at block 48). For example, if the movement detected is that of the user inserting a fuel-recharger into the vehicle 400, the integrated panel 100 may display a fuel status (e.g., 30% full, range 250 miles, or the like) to assist the user in determining whether/how much to recharge/refuel the vehicle 400. Various other scenarios are possible where based on the user's movement detected by the sensor portion 40 of the integrated panel 100, the display portion 30 of the integrated panel 100 is updated responsively. For example, The integrated panel 100 can mimic the user's movement to provide a mirror-like view on the glass pane 401. In other examples, the integrated panel 100 can be embedded in a glasspane on the vehicle 400 and display videos, interactive games, vehicle status information (e.g., fuel, navigation, speaker volume, etc.), seating for truck bed space, and other such information responsive to specific actionable movement detected. The integrated panel 100 can be embedded in the windshield of the vehicle 400 and display vulnerable road user (VRU) animation signals based on detecting specific driving patterns by the sensor portion 40. Various other display responses on the display portion 30 responsive to movement detection by the sensor portion 40 are possible in other examples. It should be noted that the display portion 30 and the sensor portion 40 are part of the same pixel element 101.

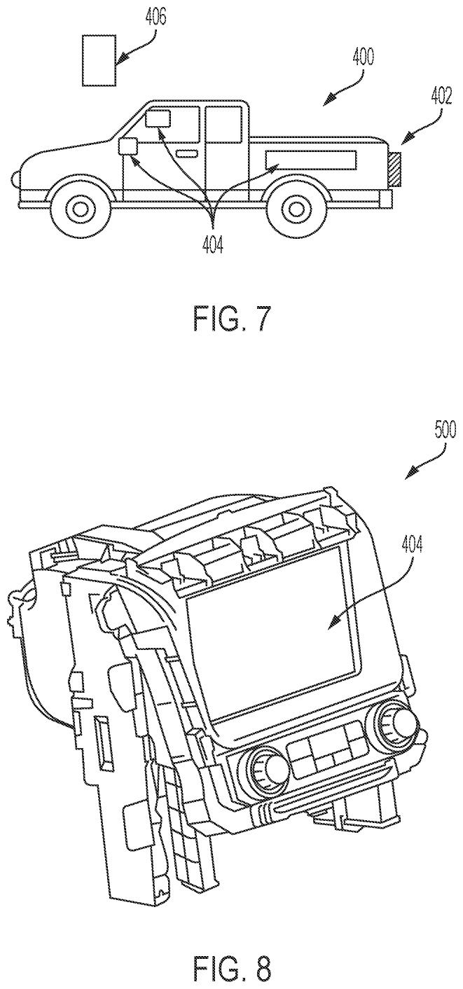

FIG. 7 depicts an example where the display panel is used as part of a vehicle 400. The integrated panel 100 can be used as part of a screen 404. The screen 404 can be inside the vehicle or on the exterior of the vehicle, or both. The screen 404 can refer to multiple display panels 100 that the vehicle 400 is equipped with. Screen 404 renders information to one or more users, such as the occupants of vehicle 400. For example, screen 404 can be part of an infotainment system. FIG. 8 depicts an example infotainment system 500 that includes a screen 404. Screen 404 of the infotainment system 500 can be used to display information such as radio channels, vehicle metrics (e.g., odometer, time, etc.), navigation data, games, video, clock, etc.

In addition, screen 404 may display the information captured by one or more sensors 402 equipped on the vehicle 400. For example, the sensors 402 can include radar, lidar, camera, ambient light sensor, or any other such sensor device. The data measured using the sensors 402 may be used to render information on the integrated panel 100. In one example, a camera captures a scene in the rear of vehicle 400, and the scene is rendered on screen 404. The screen 404, in this manner, can be used as part of a rearview assembly in lieu of (or in addition to) a rearview mirror. It is understood that scenes from other sides of the vehicle 400 can also be rendered in other examples. Alternatively, or in addition, the display panel 404 can be used to render information from other types of sensors 402 that are equipped on the vehicle 400. The screen communicates with the sensors 402 in a wired and/or wireless manner. Alternatively, or in addition, screen 404 can be used to mirror or render information from user equipment 406, such as a phone, a wearable, a laptop, a tablet computer, etc. In one or more examples, screen 404 can also be part of a separation screen between a front portion (e.g., driver's seat) and a rear portion (passenger's seat) of the vehicle 400. The screen may communicate with a user equipment 406 in a wireless and/or wired manner.

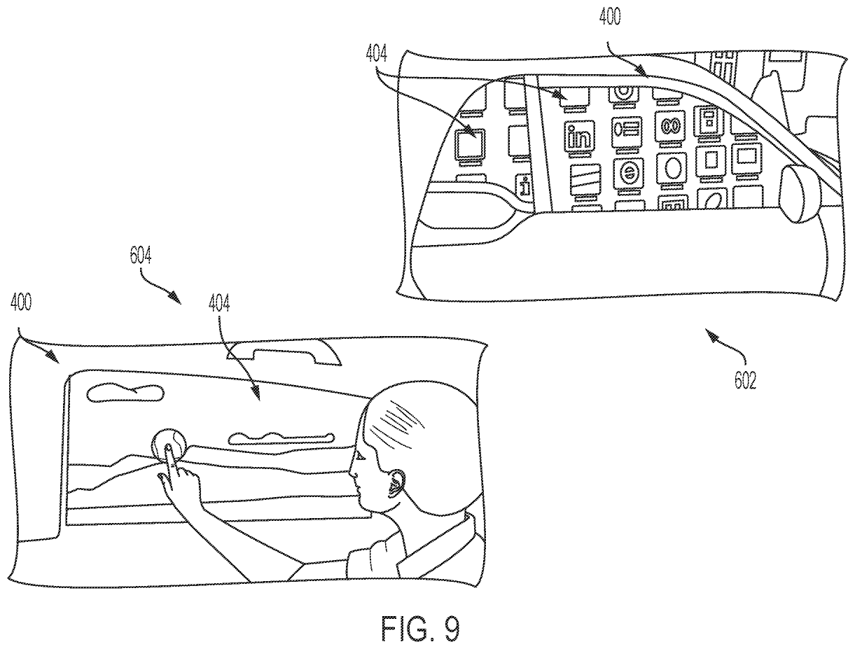

FIG. 9 shows an example view 602 where the display panel 404 is used as an exterior facing display in vehicle 400. Further, example view 604 shows the integrated panel 100 being used as an interior facing display 404 in vehicle 400. In some aspects, the integrated panel 100 can be used to provide an exterior facing display, with the sensor being used to detect movement in the interior of vehicle 400. In other words, the display portion of the integrated panel renders information directed towards the outside of the vehicle 400 based on movement detected inside the vehicle 400. Alternatively, or in addition, the integrated panel 100 can facilitate an interior facing display with the sensor 402 being used to detect movement on the exterior of the vehicle 400. In other words, the integrated panel 100 renders information inside the vehicle 400 based on movement detected outside the vehicle 400.

It is understood that the vehicle 400 is exemplary and that the technical features described herein are applicable in other types of vehicles than the one depicted. Additionally, it is understood that the positions of the sensors 402 and the screen 404 are exemplary and that in other examples, the positions, shapes, sizes of such components can vary.

It is further understood that although some possible uses of the integrated panel 100 in a vehicle 400 are described herein, the integrated panel 100 is not limited to only such uses. The integrated panel 100 can be used in various other cases where a display device is required, such as wearables, phones, computers, televisions, monitors, appliances, or any other electronic device that includes and/or uses a display to render information to one or more users.

It should be noted that although the examples display panel shown herein are of a particular shape such as rectangle, in other aspects, the display panel can have any other shape, such as circle, triangle, oval, square, etc.

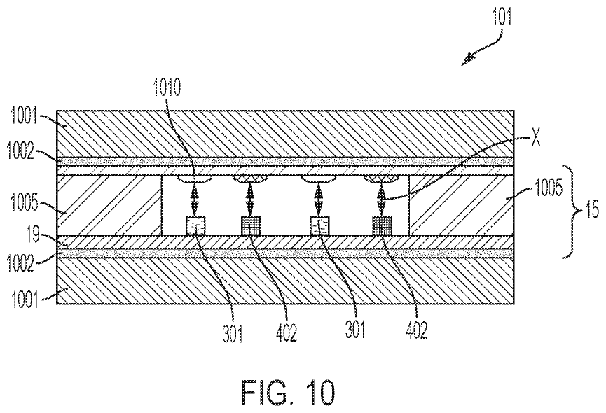

FIG. 10 shows another sectional view of a pixel element 101 according to one or more examples. In the pixel element 101 shown in FIG. 10, the display portion (30) and the sensor portion (40) overlap with each other. The display portion 30 in the illustration includes two instances of the light source 301, and the sensor portion 40 includes two sensors 402. It is understood that in other examples, different numbers of light sources and different numbers of sensors can be used. The light sources 301 and sensors 402 are placed in a particular pattern. In the illustrated example, the light sources 301 and the sensors 402 are placed alternately. However, other patterns are possible, such as two light sources 301, followed by one sensor 402, or any other such combination thereof. The light sources 301 and the sensors 402 are both placed on the backplane layer, such as the insulator 19. The pixel frame 15, which includes the light sources 301 and the sensors 402, is bonded to transparent material, such as glass (1001), using an optical bonding material (1002). In some cases, the pixel frame 15 includes a resin layer 1005. The resin layer 1005 is of material that provides strong binding and optical clarity, such as Polyvinyl butyral (PVB). Other types of interlayer materials can also be used, such as polyurethanes.

In some cases, the pixel frame 15 includes one or more micro-optic elements 1010 embedded in the optical bonding layer 1002. The micro-optic elements 1010 focus infrared (IR) light from IR LEDs. The micro-optic elements 1010 can also control the sensor's field of view to detect the reflected IR light. In some cases, the number of micro-optic elements 1010 is equal to the total number of light sources 301 and sensors 402; each of the micro-optic elements 1010 corresponding to either one of the light sources 301 or one of the sensors 402. In some aspects, the micro-optic element 1010 is placed with respect to the corresponding light source 301 or the corresponding sensor such that a distance “X” between the micro-optic element 1010 and its counterpart is equal to a focal length of the counterpart. It is understood that the placement of the micro-optic element 1010 can vary in other aspects.

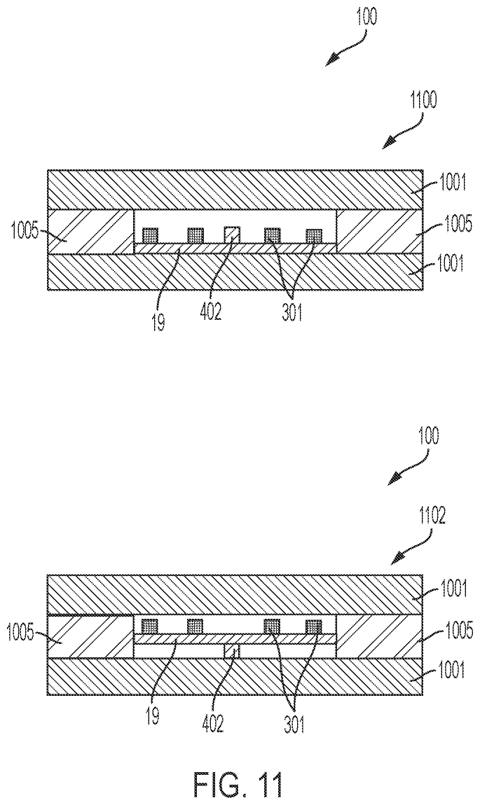

FIG. 11 depicts example views of integrated panel 100 according to one or more aspects. In the example integrated panel view 1100, the sensor 402 and the light sources 301 are on the same side of the backplane 19. In this case, the sensor 402 facilitates detecting movement in a first direction/on a first side of the backplane 19, and the light sources 301 render information in the same first direction/first side of the backplane 19.

In the example integrated panel 100 of view 1102, the sensors 402 and the light sources 301 are on opposite sides of the backplane 19. In this case, the sensor 402 facilitates detecting movement in a first direction/on a first side of the backplane 19, and the light sources 301 render information in a different (distinct) second direction/second side of the backplane 19.

While several drawings depict example views of a vehicle window that includes integrated panel 100 laminated between glass layers, the integrated panel 100 can be used in other scenarios and is not limited to use in vehicles or specific examples described herein.

Technical solutions described herein provide a device that provides a display panel that has sensors integrated with one or more pixel elements of the display panel. The light sources used for the display and the sensors that are integrated are embedded in the same backplane layer of the display panel. The integrated display panel is transparent, facilitating the integrated display panel to be embedded in glass panels, such as window panes of a vehicle.

The device also includes conductive material printed on the substrate to electrically control the light sources based on measurement signals from the sensors. Further, the device includes transparent sealing material to allow the emitted light from the light sources to reach the pigmenting material in the pixel. The device also includes a thin film transistor (TFT) layer that controls the display image (i.e., content) shown by the pixels. The image(s) rendered by the pixels are responsive (based on) to detection and measurements of movements by the sensors, where the pixels and sensors are part of an integrated panel with a pixel element including both the display portion and the sensor portion.

Several applications of such an integrated panel with display portion and sensor portion are possible. Some examples are described herein. For example, the integrated panel facilitates an interactive keypad system for locking/unlocking the vehicle. In this example, the integrated panel displays the keypad responsive to detecting a motion/specific gesture. The keypad is used to provide a specific combination of keys/touches to lock/unlock the vehicle. The input from the user can be communicated to the vehicle security system (23), which controls the locking/unlocking of the vehicle. Further yet, a separate display system of the vehicle can be updated based on the lock/unlock status. The integrated panel is embedded within the glass layers that form vehicle windows (or any other panel), thus facilitating the interactive keypad system to be laminated into the layers of the glass.

The technical solutions described herein provide a common backplane layer structure to include an array of sensors (402) and an array of light sources (301) (e.g., microLED) with connections to electrically control the two arrays. The sensors can include microsensors that can detect motion, capture intensity images, capture color images, capture depth, or other such measurements. The captured data can be analyzed in a single dimension, two dimensions (e.g., 2D images), three dimensions (e.g., 2D images+depth), or any other dimensionality.

The integrated panel can use the light sources or include additional light sources to brighten a specific vicinity of the integrated panel for the sensors 402 to detect and capture movement in the specific vicinity.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed but will include all embodiments falling within the scope thereof.

1. A display device comprising:
a plurality of pixel elements, each pixel element comprising a display portion and a sensor portion to detect movement within a predetermined vicinity of the display device, wherein the detected movement is at least six inches from the display device, and wherein:
the display portion comprises a light source embedded in a backplane layer, the light source to cause an image to be rendered by the display device; and
the sensor portion comprises a movement sensor embedded in the backplane layer, the movement sensor to detect the movement within the predetermined vicinity of the display device; and
a controller coupled to a light sensor that detects an amount of ambient light, wherein, in response to the light sensor measuring an amount of ambient light being below a predetermined threshold, the controller provides an electric signal to the light source to cause the light source to emit light within the predetermined vicinity to facilitate detecting the movement by the movement sensor.

2. (canceled)

3. The display device of claim 1, wherein the light source is a plurality of light sources.

4. The display device of claim 1, wherein the light source is a microLED.

5. The display device of claim 1, wherein the movement sensor includes: a camera, a depth sensor, radar, lidar, ambient light sensor, vertical-cavity surface-emitting laser (VCSEL) diode, single-photon avalanche diode (SPAD), or combinations thereof.

6. The display device of claim 1, wherein the controller is further configured to:
receive a movement detection signal from the movement sensor; and
in response, based on the movement detection signal, cause the light source to change the image being rendered.

7. (canceled)

8. The display device of claim 1, wherein the controller is configured to:
cause the pixel elements to display a lock screen using the display portion of each of the pixel elements;
receive, from the sensor portion of one or more pixel elements from the plurality of pixels, a movement detection; and
in response to the movement detection, cause the pixel elements to display a keypad to lock or unlock a vehicle.

9. The display device of claim 1, wherein the plurality of pixel elements is a first plurality, and the display device further comprises a second plurality of pixel elements, wherein each of the second plurality of pixel elements comprises only the display portion.

10. A method comprising:
detecting, using a movement sensor of a sensor portion of a pixel element of a display panel, a movement within a predetermined vicinity at a distance from the display panel, wherein the detected movement is at least six inches from the display panel, wherein the display panel is embedded on an exterior of a vehicle, and wherein the display panel is transparent;
based on detecting the movement, displaying a keypad by a display portion of the pixel element;
in response to an input provided via the keypad displayed by the display portion, locking or unlocking the vehicle;
determining, by a controller coupled to the display panel and a light sensor, that an amount of ambient light measured by the light sensor is below a predetermined threshold; and
in response to determining the amount of the ambient light measured by the light sensor is below a predetermined threshold, providing, by the controller, an electric signal to a light source coupled to the display portion to cause the light source to emit light within the predetermined vicinity to facilitate detecting the movement by the movement sensor.

11. The method of claim 10 wherein the pixel element is a plurality of pixel elements of the display panel.

12. The method of claim 10 wherein the sensor portion and the display portion are commonly located on the same backplane layer of the pixel element.

13. The method of claim 10 wherein the pixel element is a first pixel element that comprises the display portion and the sensor portion, and wherein the display panel further comprises a second pixel element that comprises only the display portion.

14. (canceled)

15. The method of claim 10, wherein the light source comprises one or more light sources, and the light sources comprises a microLED.

16. The method of claim 10, wherein the movement sensor includes: a camera, a depth sensor, radar, lidar, ambient light sensor, vertical-cavity surface-emitting laser (VCSEL) diode, single-photon avalanche diode (SPAD), or combinations thereof.

17. A vehicle comprising:
a transparent display panel embedded within glass layers of a glass panel, the display panel comprising:
a plurality of pixel elements, each pixel element comprising a display portion and a sensor portion, wherein:
the display portion comprises a light source to cause an image to be rendered by the display; and
the sensor portion comprises a movement sensor, the movement sensor to detect movement within a predetermined vicinity at a distance from the vehicle wherein the detected movement is at least six inches from the vehicle; and
a controller coupled to a light sensor that detects an amount of ambient light, wherein, in response to the light sensor measuring an amount of ambient light being below a predetermined threshold, the controller provides an electric signal to the light source to cause the light source to emit light within the predetermined vicinity to facilitate detecting the movement by the movement sensor.

18. The vehicle of claim 17, wherein the display panel is coupled with a vehicle security system of the vehicle, and the display portion renders a status of the vehicle being locked or unlocked.

19. The vehicle of claim 18, wherein in response to detecting, by the sensor portion of the pixel element, the movement within the predetermined vicinity, the display portion renders a keypad to lock or unlock the vehicle.

20. The vehicle of claim 19, wherein the vehicle is locked or unlocked based on an input via the keypad.
